(19) United States
(12) Patent Application Publication
(10) Pub. No.: US 2012/0313588 A1
(43) Pub. Date: Dec. 13, 2012

(54) OCCUPANCY SENSOR WITH CONDITIONAL ENERGY TRANSFER FROM LOAD

(75) Inventors: Brian J. Carberry, Portland, OR (US); Daniel M. Wright, Beaverton, OR (US)

(73) Assignee: LEVITON MANUFACTURING CO INC, MELVILLE, NY (US)

(21) Appl. No.: 13/579,888

(22) PCT Filed: Feb. 23, 2010
(86) PCT No.: PCT/US10/25003

§ 371 Date: Aug. 17, 2012

(51) Int. Cl. H02J 7/00

(52) U.S. Cl. 320/134

(57) ABSTRACT

An occupancy sensor may control a load in response to its own operating conditions. In some embodiments, the occupancy sensor may include an energy storage device to operate the occupancy sensor when a load it controls is not energized. The occupancy sensor may energize the load to transfer energy from the load to the occupancy sensor when the amount of energy stored at the occupancy sensor reaches a threshold level. In some other embodiments, the occupancy sensor may include two sensing circuits and a connection to transfer energy from a load it controls to the occupancy sensor when the load is energized. The occupancy sensor may disable one of the sensing circuits when the load is not energized.

### BACKGROUND

Occupancy sensors are used to monitor the presence of occupants in indoor and outdoor spaces. Occupancy sensors conserve energy by automatically turning off lighting and other electrical loads associated with a space when the space is unoccupied. Occupancy sensors also perform a convenience function by automatically turning on lighting and other loads when an occupant enters the space.

An occupancy sensing system generally includes at least two major components: an occupancy sensor and a switching device. The sensor generally needs to be positioned in a location that is selected to have a clear view of the entire space that is to be monitored for occupants. This type of location, however, is usually not convenient for the switching device, so the switching device is typically located in a power pack, wall switch, relay cabinet, or other location remote from the occupancy sensor. Some occupancy sensing systems include control wiring that runs between the occupancy sensor and the switching device. Other systems utilize wireless communications to eliminate the need for wiring between the occupancy sensor and switching device.

### BRIEF DESCRIPTION OF THE DRAWINGS

FIG. 1 illustrates an embodiment of an occupancy sensing system according to some inventive principles of this patent disclosure.

FIG. 2 illustrates an embodiment of a wireless occupancy sensor according to some inventive principles of this patent disclosure.

FIG. 3 illustrates an example embodiment of a wireless occupancy sensing system according to some inventive principles of this patent disclosure.

FIG. 4 illustrates another example embodiment of a wireless occupancy sensing system according to some inventive principles of this patent disclosure.

FIG. 5 illustrates another embodiment of a wireless occupancy sensor according to some inventive principles of this patent disclosure.

FIG. 6 illustrates another embodiment of a wireless occupancy sensor according to some inventive principles of this patent disclosure.

FIG. 7 illustrates another example embodiment of a wireless occupancy sensing system according to some inventive principles of this patent disclosure.

### DETAILED DESCRIPTION

Prior art occupancy sensors control loads only in response to external parameters such as the presence of occupants, ambient lighting conditions, and commands from building automation or energy management systems. Some of the inventive principles of this patent disclosure relate to methods and apparatus that enable an occupancy sensor to also control a load in response to its own operating conditions such as the amount of energy stored at the occupancy sensor, the level of power consumption of the occupancy sensor, etc. Some additional inventive principles relate to coordinating the operation of an occupancy sensor with the amount of power that is available to the occupancy sensor.

### Generic System

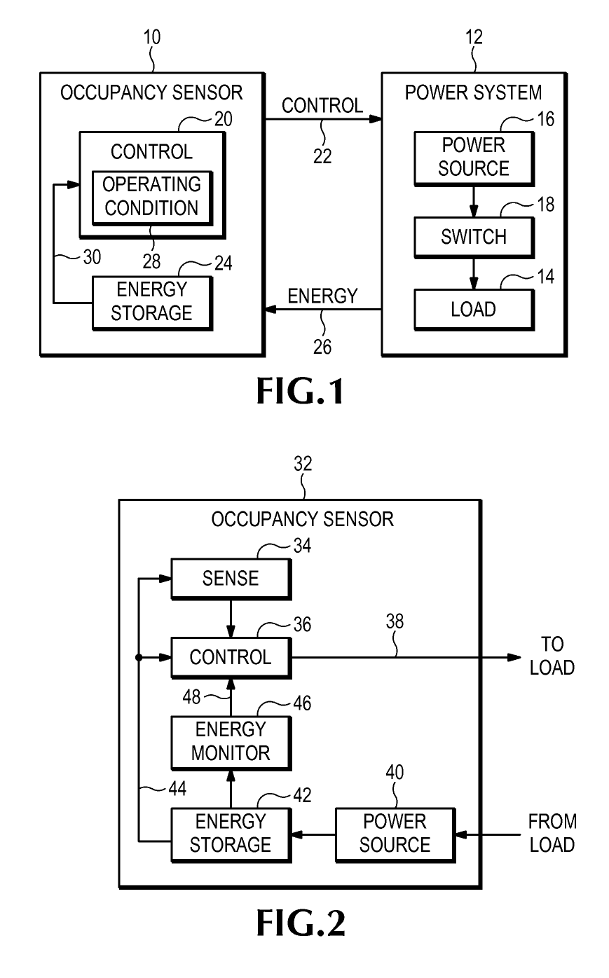

FIG. 1 illustrates an embodiment of an occupancy sensing system according to some inventive principles of this patent disclosure. The embodiment of FIG. 1 includes an occupancy sensor 10 and a power system 12. The power system 12 includes a load 14 which receives power from a power source 16 through a power switch 18. The occupancy sensor 10 includes control functionality 20 that generates a control signal 22 to control the power switch 18 in response to the occupied condition of a space that the occupancy sensor monitors. The occupancy sensor 10 also includes energy storage 24 to provide enough power 30 to enable the occupancy sensor to operate for a substantial length of time without an external source of power. The system is constructed and arranged so that energy 26 from the load can be selectively transferred to the occupancy sensor. The control functionality 20 includes functionality 28 that enables the occupancy sensor to control the load and/or its own operation in response to an operating condition of the occupancy sensor such as the amount of energy stored at the occupancy sensor, the level of power consumption of the occupancy sensor, etc., and/or in response to the amount of power available to the occupancy sensor.

The components of the power system 12 may be implemented in any suitable form. For example, the power source 16 may be an AC power source supplied from a utility grid at any of the standard voltages and frequencies. Alternatively, the power source may be derived from a local or backup generator, wind turbine, photovoltaic panel, etc., in AC or DC form and at any suitable frequency, voltage, etc. The power switch 18 may include any suitable form of isolated or non-isolated power switch including an air-gap relay, solid state relay, or other switch based on SCRs, triacs, transistors, etc. The switch may provide power switching in discrete steps such as on/off switching, with or without intermediate steps, or as continuous switching such as phase control to provide dimming of lamps or fan speed control. The load 14 may be a lighting load, ceiling fan, exhaust fan, heater, air conditioner, or any other load such as all or a portion of a heating, ventilation and air conditioning (HVAC) system that is associated with a space that is monitored by the occupancy sensor 10. As used herein, the term load includes not only the load, but also the power switch that controls the load or other point in the power system that is controlled by the occupancy sensor and can transfer energy to the occupancy sensor.

The control and other functionality of the occupancy sensor may also be implemented in any suitable form. For example, the control functionality may be implemented with analog and/or digital hardware, software, firmware, or any suitable combination thereof. The energy storage 24 may be implemented with a battery, a capacitor, including large valued capacitors that are referred to as super capacitors or ultra capacitors, or any other suitable storage device. The operating condition functionality 28 may be entirely or partially integral with, or separate from, the control functionality 20.

The control signal 22 may be transmitted over a wired connection, or it may be transmitted wirelessly using infrared (IR), radio frequency (RF) or any other suitable transmission technology. The energy 26 from the load may be transferred to the occupancy sensor 10 through a high or low-voltage wired connection. Alternatively, the energy 26 may be transferred through a medium that enables the occupancy sensor to harvest the energy from its environment. For example, if the load 14 includes a circulating blower for an HVAC system, the occupancy sensor may include a mechanical transducer that converts vibrations from the HVAC system to electric power that can be stored in a capacitor. As another example, if the load 14 includes a lamp, the occupancy senor may include a photovoltaic (PV) cell that converts light from the lamp to electric power. As yet another example, energy from vibrations may be harvested through a device such as a piezoelectric element.

### Self-Charging Wireless Occupancy Sensor

FIG. 2 illustrates an embodiment of a wireless occupancy sensor according to some inventive principles of this patent disclosure. The occupancy sensor 32 of FIG. 2 includes a sensing circuit 34 that utilizes any suitable occupancy sensing technology such as passive infrared (PIR) sensing to detect the presence of one or more occupants in a space that is monitored by the occupancy sensor. A control circuit 36 generates a wireless control signal 38 to control a load associated with the monitored space in response to occupancy information from the sensing circuit 34. A power source 40 is arranged to receive energy from the load, when the load is energized, to provide power to the control circuit 36, sensing circuit 34 and/or any other functionality within the occupancy sensor. An energy storage device 42 also receives energy from the power source 40 when the load is energized. By storing excess energy that is available when the load is energized, the energy storage device can provide enough power 44 to enable the occupancy sensor to operate for a substantial length of time when the load is not energized.

The occupancy sensor 32 also includes energy monitoring functionality 46 to monitor the amount of energy stored in the energy storage device 42. If the stored energy level reaches a predetermined value, the monitoring functionality 46 may cause the control circuit 36 to turn on the load, thereby causing energy to be transferred from the load to the occupancy sensor through power source 40. For example, the control circuit 36 and energy monitoring functionality 46 may be configured to energize the load shortly before the amount of energy stored at the occupancy sensor drops to a level that is insufficient to operate the occupancy sensor.

The energy monitoring functionality 46 may be implemented with analog and/or digital hardware, software, firmware, or any suitable combination thereof. For example, the energy monitoring functionality 46 may be realized with an analog under-voltage lockout (UVLO) device arranged to monitor the voltage of a battery or capacitor used as the energy storage device 42. When the voltage drops below a predetermined threshold, the UVLO device asserts a recharge signal 48 that causes the control circuit 36 initiate a recharge event that energizes the load, thereby transferring energy to the occupancy sensor. As another example, the energy monitoring functionality 46 may be implemented with a microcontroller or other digital device that converts the voltage or other parameter of the energy storage device 42 to a digital form. The energy monitoring functionality 46 may be entirely or partially integral with, or separate from, the control circuit 36.

In some embodiments, a recharge event may be implemented as a simulated occupancy event. That is, the control circuit 36 may interpret the recharge signal 48 the same as an occupancy event from the sensing circuit 34. In such an example, the load may remain energized for an amount of time that is determined by a normal time-out feature of the occupancy sensing system which is typically between 30 seconds and 30 minutes. The energy monitoring functionality 46 may also include hysteresis or other functionality that causes the load to be turned on for multiple time-out durations, or one continuous special length duration, to replenish the energy storage device to a full state.

In other embodiments, the energy monitoring functionality 46 may be implemented in a manner that causes the load to be turned off if the energy storage device reaches a fully replenished state before the end of a normal time-out cycle.

The wireless control signal 38 may be transmitted through IR, RF or any other suitable wireless transmission technology.

The power source 40 may be implemented in any suitable manner. For example, it may be hard wired to the load with high or low-voltage wiring. As another example, the power source 40 may be implemented with an energy converter that enables the occupancy sensor to harvest energy that is transferred from the load to the environment in which the occupancy sensor is installed. Examples of energy converters include PV cells, and mechanical, thermal or vibration transducers.

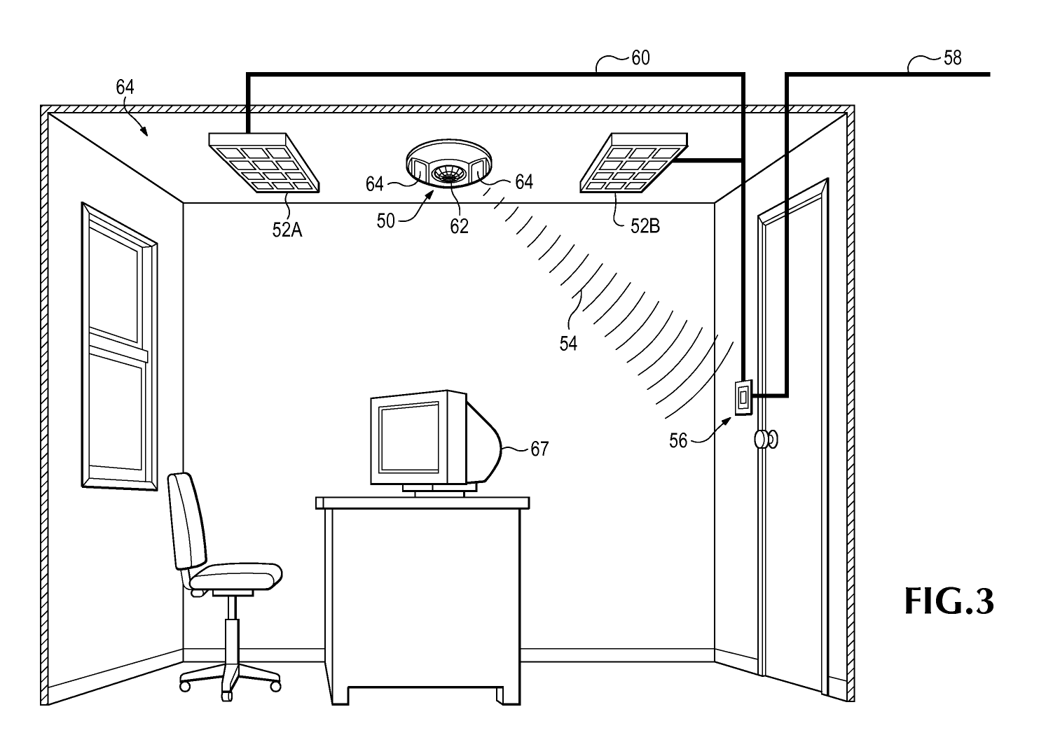

FIG. 3 illustrates an embodiment of a wireless occupancy sensing system that illustrates some example implementation details that can be used to realize the embodiment of FIG. 2. The embodiment of FIG. 3 includes a wireless occupancy sensor 50 arranged to control fluorescent light fixtures 52A-52B by transmitting a wireless occupancy signal 54 to a wall switch 56. Wall switch 56 that has a wireless receiver and timing logic to implement a time-out feature that turns the light fixtures off a predetermined period of time after receiving an occupied signal from the wireless occupancy sensor 50. The wall switch 56 includes a power switch to control the flow of high-voltage AC power from line side wiring 58 to load side wiring 60.

The wireless occupancy sensor 50 utilizes PR sensing and includes a lens 62 to direct IR light to a PIR sensor circuit. An analog control circuit monitors the PIR sensor circuit and activates an RF transmitter module whenever the sensor circuit detects an occupant in the monitored space 64. When activated, the RF transmitter module transmits the wireless occupancy signal 54 to the wall switch 56 which closes the power switch to energize the light fixtures 52A-52B, if they are not already energized, and re starts the time-out feature.

The wireless occupancy sensor 50 also includes one or more photovoltaic (PV) cells 64 to provide operating power for the sensing circuit, control circuit and transmitter module. An energy storage capacitor such as a super capacitor or ultra capacitor is included to store excess energy from the photocells while the light fixtures 52A-52B are energized. The stored energy enables the occupancy sensor to continue operating for a substantial length of time even after the light fixtures are turned off and if no ambient light is available in the space 64.

The wireless occupancy sensor 50 further includes a voltage monitoring circuit arranged to monitor the voltage on the capacitor and signal the control circuit when the capacitor voltage drops below a predetermined threshold. The threshold may be set, for example, at a voltage level slightly above the minimum voltage at which the occupancy sensor operates properly. The control circuit then activates the transmitter module and causes the wall switch 56 to turn on the lights for the duration of the time-out counter. Thus, the capacitor is charged by the PV cells from light energy provided by the lighting load. The voltage monitoring circuit may include hysteresis that requires the capacitor voltage to rise to a second threshold that is higher than the first threshold before the voltage monitoring circuit stops signaling the control circuit to indicate a low-voltage condition. Thus, the control circuit continues to periodically activate the transmitter module and signal the wall switch to restart the time-out counter until the capacitor voltage rises above the second threshold.

A potential advantage of the embodiment of FIG. 3 is that it may enable an existing wireless occupancy sensor to be modified to provide self-activating recharge functionality according to the inventive principles of this patent disclosure. For example, in some embodiments, a self-activating recharge function may be added to an existing wireless occupancy sensor design by adding a simple, inexpensive, three-terminal under-voltage lockout (UVLO) device.

Another potential advantage is that it may enable a wireless occupancy sensor to continue to operate indefinitely, even during times when no ambient light is available, and no occupants are detected in the monitored space. Whenever the amount of energy stored in the occupancy sensor approaches a minimum operating level, the voltage monitoring circuit causes the occupancy sensor to energize the light fixtures and replenish the stored energy.

The details described above with respect to the embodiment of FIG. 3 are for illustrative purposes only, and the inventive principles are not limited to these details. The embodiment of FIG. 3 can be modified in countless way in accordance with the inventive principles. For example, any suitable type of occupancy sensing technology, energy storage device, energy conversion device, etc. may be used. The transmitter module may be integral with, or separate from, the control circuit which may also be implemented in any other suitable form including a microcontroller or other digital circuitry.

The transmitter may be realized with any suitable technology including RF modules that implement any custom or standardized RF communication protocol including EnOcean, ZigBee, Z-Wave, etc. The wireless transmission may also be implemented with infrared or other non-RF technology. A wall switch is illustrated as a convenient location for both the wireless receiver and power switch, but these components may be located either separately or together in any other suitable location or form including power packs, relay cabinets, junction boxes, etc Likewise, the load may take the form of a fan, heater, HVAC system, etc., and the PV cells may be replaced with other types of transducers to enable the occupancy sensor to harvest energy from the load in any form.

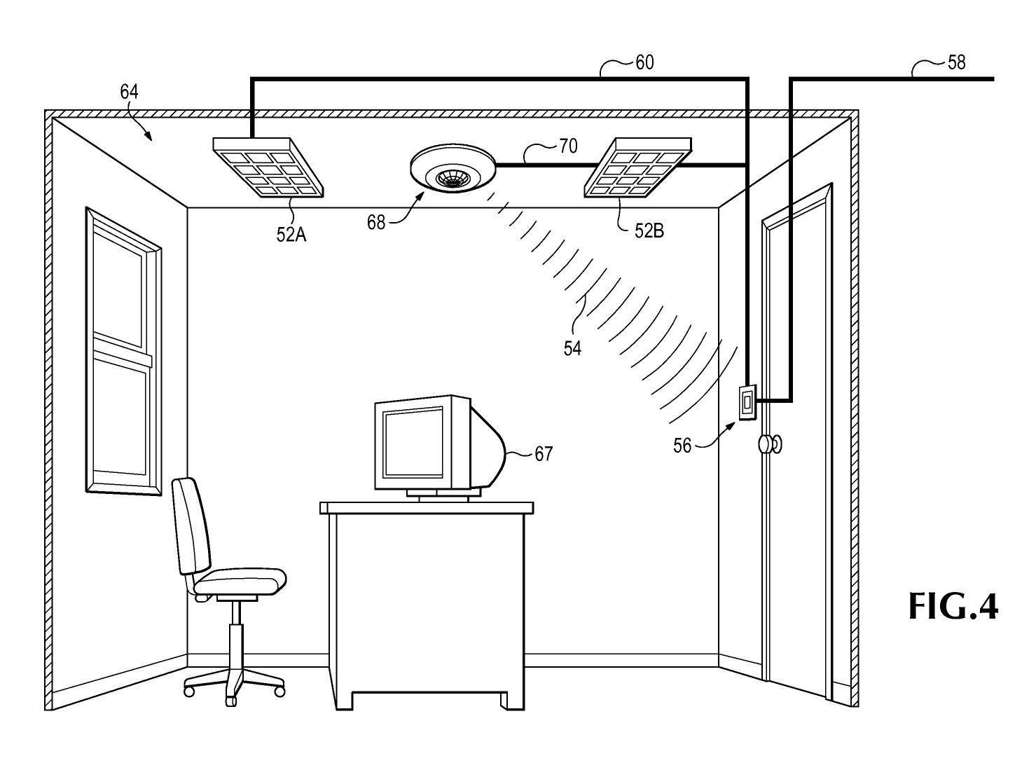

FIG. 4 illustrates another embodiment of a wireless occupancy sensing system that illustrates some example implementation details that can be used to realize the embodiment of FIG. 2. The embodiment of FIG. 4 is similar to the embodiment of FIG. 3. However, in the embodiment of FIG. 4, the wireless occupancy sensor 68 does not include an energy converter such as a PV cell. Instead, it receives power from light fixture 52B through low-voltage wiring 70. During times when the space 64 is unoccupied and the light fixtures 52A-52B are not energized, the occupancy sensor operates using the energy stored in the capacitor. When the capacitor voltage drops below a first predetermined threshold, the voltage monitoring circuit causes the control circuit to activate the transmitter module and send the wireless signal 54 to wall switch 56 which turns on the lights for the duration of the time-out counter.

When the light fixtures 52A-52B are energized, the low-voltage connection 70 transfers energy to the occupancy sensor and replenishes the energy stored in the capacitor. The voltage monitoring circuit causes the control circuit to continue transmitting an occupancy signal until the voltage of the capacitor reaches a second threshold level, which may be slightly above the first threshold, a fully charged state, or any other suitable level. The control circuit then stops transmitting the occupancy signal, and the wall switch turns off the lights after the time-out period. The transfer of energy from the light fixtures to the occupancy sensor then stops, and the occupancy sensor reverts to operating from the energy stored in the capacitor until the capacitor voltage drops below the first threshold again.

Although the embodiment of FIG. 4 includes wiring between the occupancy sensor and the load, it is still wireless in that the occupancy sensor can continue to operate for a substantial period of time without receiving any power from the wiring.

A potential advantage of the embodiment of FIG. 4 is that it may reduce the cost of both the occupancy sensing system and installation. Because the occupancy sensor can obtain power through wiring 70, the cost and complexity of a PV cell or other energy converter may be eliminated. Moreover, low-voltage wiring can typically be installed easily above a dropped ceiling and is generally less expensive to install compared to high-voltage wiring, e.g., 120 VAC.

Moreover, the low voltage for wiring 70 is often readily available at many types of loads. For example, fluorescent light fixtures and/or ballasts often include, or are connected to, 24 VDC supplies or other low voltage supplies for operating occupancy sensors and/or relays, for signaling purposes, i.e., for communication with building automation and/or energy management systems, etc.

The details described above with respect to the embodiment of FIG. 4 are for illustrative purposes only, and the inventive principles are not limited to these details. The embodiment of FIG. 4 can be modified in countless way in accordance with the inventive principles, including in the manners described above with respect to the embodiment of FIG. 3. Moreover, the embodiment of FIG. 4 can be modified in additional ways. For example, low voltage power can be obtained not only from the light fixture and/or ballast, but from any other portion of the power system that is controlled by the occupancy sensor such as a power pack which may be located in, or attached to, the fixture. A power pack may also be located anywhere above a dropped ceiling, in a suitable plenum, in a junction box in a wall, floor or ceiling, etc. As another example, low-voltage wiring is described as an example technique for transferring energy from the load to the occupancy sensor, but any suitable type of wiring including high-voltage wiring may be used.

### Self-Powered PR with Ultrasonic Occupancy Sensing

Some additional inventive principles of this patent disclosure relate to methods and apparatus that enable an occupancy sensor to selectively transfer energy from a load to the occupancy sensor in response to the level of power consumption of the occupancy sensor and/or to control its own operation in response to the amount of power available to the occupancy sensor. The level of power consumption may be related, for example, to the type of sensing technology used by the occupancy sensor.

Sensing technologies can generally be characterized as either active or passive. Passive technologies do not involve the active emission of any type of energy in the monitored space. Instead, passive technologies rely on the detection of energy given off by the occupants themselves, or reflected by the occupants from ambient sources. An example of a passive occupancy sensing technology is passive infrared (PIR) sensing. Another type of passive occupancy sensing technology is video sensing which relies on ambient light that is reflected by an occupant and detected by a video sensor such as a charge coupled device (CCD). Still another type of passive occupancy sensing technology is audio or microphonic technology which listens for sounds.

With active technologies, some type of energy is emitted in the monitored space. The emitted energy is reflected by an occupant and converted into an electric signal by a suitable sensor. An example of an active occupancy sensing technology is ultrasonic (U/S) sensing. In an ultrasonic system, the monitored space is flooded with ultrasonic waves that are constantly emitted by an ultrasonic driver. An ultrasonic sensor detects occupants by analyzing waves that are reflected by occupants and/or other objects in the monitored space.

Some occupancy sensors use a combination of sensing technologies. For example, PR is generally more accurate for detecting large motion such as a person walking into a room in a path that is directly within the line-of-sight of the occupancy sensor. Ultrasonic systems tend to be more sensitive for detecting small motion, such as a person working at a desk, and motion that is hidden from the line-of-sight of the occupancy sensor, such as behind partitions in an office or restroom. The added sensitivity, however, may cause false occupied readings. Therefore, an occupancy sensor may initially use only PIR sensing to determine that the monitored space has become occupied. Once the space is initially determined to be occupied, an occupied reading from either PIR or ultrasonic may be used to determine that the space continues to be occupied.

Wireless occupancy sensors have limited amounts of power on which to operate. Thus, wireless occupancy sensors are generally limited to using passive sensing technologies, since active sensing technologies typically require larger amounts of power in order to emit energy into the monitored space. Moreover, even some passive sensing technologies such as audio and video sensing consume relatively large amounts of power because signals from audio and video sensors typically must be amplified and/or heavily processed to convert them to a form that is usable by an occupancy sensor.

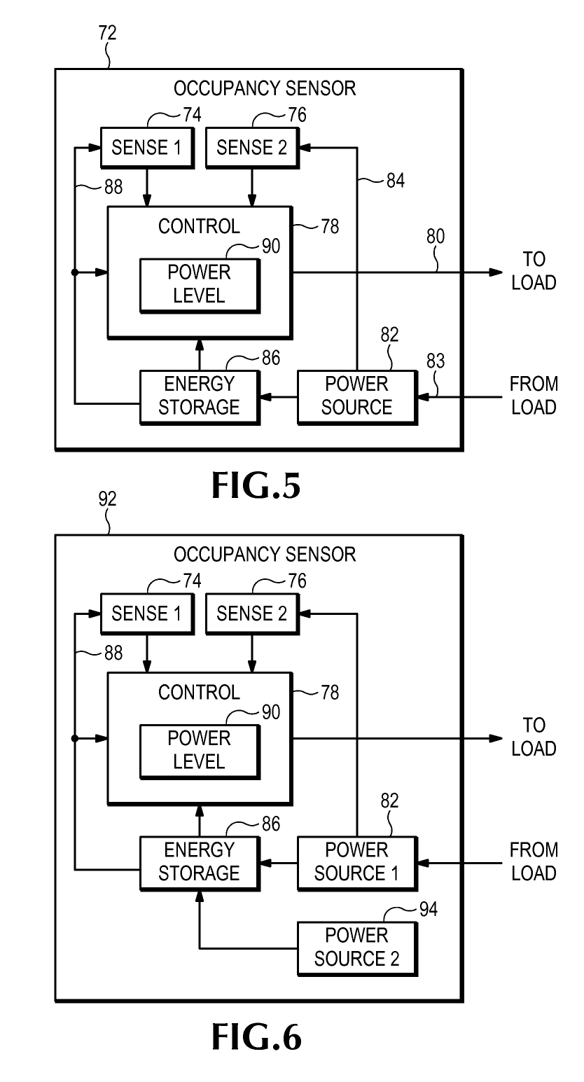

FIG. 5 illustrates another embodiment of a wireless occupancy sensor according to some inventive principles of this patent disclosure. The occupancy sensor 72 of FIG. 5 includes a first sensing circuit 74 and a second sensing circuit 76, either of which may utilize any suitable occupancy sensing technology to detect the presence of one or more occupants in a space that is monitored by the occupancy sensor. In this example, the first sensing circuit 74 utilizes a relatively low power occupancy sensing technology such as PR sensing, and the second sensing circuit 76 utilizes a relatively high power occupancy sensing technology such as audio sensing.

A control circuit 78 generates a wireless control signal 80 to control a load associated with the monitored space in response to occupancy information from the sensing circuits 78 and 80. The control circuit is also capable of enabling or disabling one or both of the sensing circuits. A power source 82 is arranged to receive energy 83 from the load, when the load is energized, to provide power 84 to the control circuit 78, sensing circuits 72 and 74 and/or any other functionality within the occupancy sensor. The power source 82 may be implemented in any suitable manner including a wired connection from the load, an energy converter to harvest environmental energy from the load, etc.

An energy storage device 86 also receives energy from the power source 82 when the load is energized. By storing excess energy that is available when the load is energized, the energy storage device 86 can provide enough power 88 to enable the occupancy sensor 72 to operate for a substantial length of time when the load is not energized.

The control circuit 78 includes power level control functionality 90 to coordinate operation of the sensing circuits 74 and 76, and the wireless control signal 80 with the availability of power from the power source 82. The power level control functionality may include energy monitoring functionality to monitor the amount of power in energy storage device 86 in a manner similar to energy monitoring functionality 46 in the embodiment of FIG. 2.

An example operating method for the embodiment of FIG. 5 is as follows. When the monitored space is unoccupied and the lights are off, the second sensing circuit 76 is turned off by the control circuit 78, and only the first sensing circuit 74 is used to monitor the space. No power is available from the power source 82, but the first sensing circuit utilizes a relatively low power occupancy sensing technology, so adequate power 88 is provided by energy storage device 86 to operate the occupancy sensor for a substantial period of time. If the amount of energy in energy storage device 86 drops below a predetermined threshold level, the power level control functionality 90 may cause the control circuit 78 to temporarily turn on the load, thereby causing energy to be transferred from the load to the occupancy sensor through power source 82, and thereby replenish the energy storage device 86.

When the first sensing circuit 74 detects an occupant in the monitored space, the control circuit 78 transmits the wireless control signal 80 to turn on the load, thereby causing energy to be transferred from the load to the occupancy sensor through power source 82. With additional power now available from the power source 82, the control circuit 78 turns on the second sensing circuit 76, which utilizes a relatively high power occupancy sensing technology. The occupancy sensor can then utilize one or both of the sensing circuits 74 and 76 to monitor the space. Once the space is determined to be unoccupied, the control circuit 78 stops sending the control signal 80 and disables the second sensing circuit 76. The second sensing circuit 76 may be disabled immediately upon detection of an unoccupied state, or after a suitable time delay, for example, a time delay that matches the time-out delay of the occupancy sensing system. Alternatively, the second sensing circuit 76 may be disabled when the control circuit 78 determines that the load has been turned off, for example, by monitoring the state of the energy storage device 86 to determine when the stored energy level begins dropping rapidly due to the absence of replenishment from the power source 82. After the load is turned off, the control circuit 78 typically leaves the load off until the first sensing circuit 74 detects an occupant in the monitored space again.

FIG. 6 illustrates another embodiment of a wireless occupancy sensor according to some inventive principles of this patent disclosure. The occupancy sensor 92 of FIG. 6 is similar to the embodiment of FIG. 5, but the embodiment of FIG. 6 includes a second power source 94. The second power source 94 may be complementary to the first power source 82. For example, if the first power source 82 is implemented with a wired connection to a load, the second power source may be implemented with an energy converter to harvest energy from the monitored space. Thus, the second power source may operate the first sensor circuit 74 which may require less power to operate, while the first power source 82 may operate the second sensor circuit 76 which may require a relatively greater amount of power to operate.

As with the embodiments of FIGS. 2-4, the components in the embodiments of FIGS. 5-6 can be implemented in any suitable form. For example, the control circuit 78 may include analog and/or digital hardware, software, firmware, or any suitable combination thereof. The control circuit may also include functionality for transmitting the wireless control signal. The control circuitry may be realized, for example, with a single module that includes a wireless transmitter and a microcontroller to implement all functions of the control circuit including the power level control functionality.

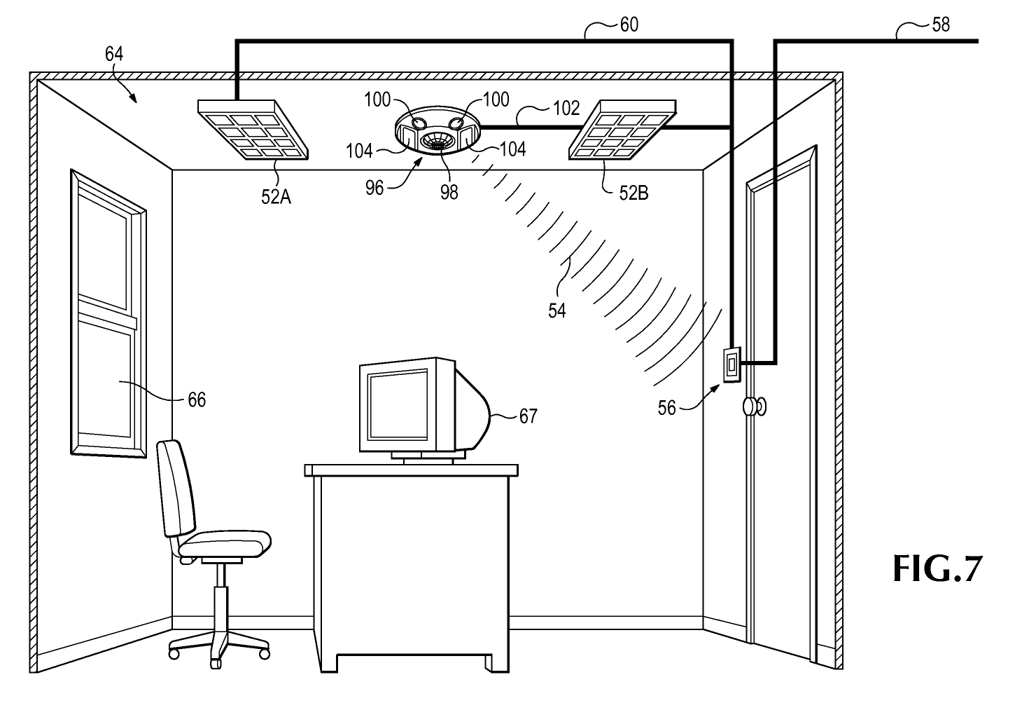

FIG. 7 illustrates an embodiment of a wireless occupancy sensing system that illustrates some example implementation details of a system that utilizes the embodiment of FIG. 6. The system of FIG. 7 is similar to the system of FIG. 4, but here, the occupancy sensor 96 includes a first sensing circuit that utilizes PR sensing through a lens 98, and a second sensing circuit that utilizes active ultrasonic sensing through one or more U/S receivers, transmitters and/or transducers 100. There may be, for example, a one or more transceivers, one transmitter and one or two receivers, two transmitters and two receivers, etc.

In an alternative embodiment, the second sensing circuit may utilize audio or video sensing, in which case, the U/S transducers 100 may be replaced by audio or video sensors. A wired connection 102 provides a first power source to transfer energy from light fixture 52B to the occupancy sensor, while photovoltaic (PV) cells 104 provide a second power source for the occupancy sensor. The occupancy sensor 96 also includes an energy storage device to provide power to the occupancy sensor when the light fixture 52B is not energized and the wired connection 102 does not provide any power.

When the space 64 is unoccupied, and the lights are off, the occupancy sensor 96 disables the U/S (or audio or video) sensing circuit and utilizes only the PIR sensing circuit to monitor the space for an occupant. No power is available through the wired connection 102, and the occupancy sensor operates solely on power stored in the energy storage device in the occupancy sensor, as well as any power converted by PV cells 104 from ambient light, which may be available, for example, from window 66.

When the PR sensing circuit detects an occupant in the space 64 by sensing a large motion, the occupancy sensor 98 transmits the wireless occupancy signal 54 to wall switch 56 which turns on the lights and restarts the time-out counter. With the light fixture 52B energized, the wired connection 102 provides additional power to the occupancy sensor which can then enable the U/S (or audio or video) sensing circuit to monitor for small motion and provide a more accurate determination of the occupied state of the space.

When the occupancy sensor determines that the space is no longer occupied, it stops transmitting the wireless occupancy signal 54 to the wall switch 56, which turns off the lights after the time-out delay. The occupancy sensor 98 may disable the U/S (or audio or video) sensing circuit immediately after determining that the space is unoccupied or if a user manually turns off the wall switch. Alternatively, the U/S (or audio or video) sensing circuit may remain enabled until the lights are turned off after a delay time and the wired connection 102 no longer provides additional power. The occupancy sensor then reverts to operating solely from the energy storage device and/or the PV cells 104 and monitoring the space using only the PIR sensing circuit to sense large motion.

Optionally, the occupancy sensor may turn on the lights even when the space is not occupied to enable the PV cells to replenish the energy storage device when the amount of stored energy drops to a minimum operating level.

A potential benefit of the embodiments described above is that they may enable dual-technology occupancy sensing to be added to a power system quickly, and at a relatively low cost. Moreover, they may also enable dual-technology occupancy sensing to be added to an existing single technology wired or wireless occupancy sensing system quickly, and at a relatively low cost.

Another potential benefit is that components to implement an occupancy sensing system according to the inventive principles of this patent disclosure may be distributed as a retrofit kit, which may be relatively easy and inexpensive to distribute. A retrofit kit may include, for example, a wireless receiver that may be connected to control a load in the form of a wall switch, power pack, relay module, etc., along with a wireless occupancy sensor as described with respect to one of the embodiments above. The receiver and occupancy sensor may be installed without the need to run additional wiring through walls or other inaccessible locations. If a low voltage power source is available at one of the loads controlled by the receiver, a low voltage wired connection may be run between the load and the occupancy sensor. If the load is, for example, a light fixture in a dropped ceiling, it may be possible to make the wired connection at a very low cost. The retrofit kit may also include a replacement light fixture and/or ballast that can provide the low voltage power supply.

Components to implement an occupancy sensing system according to the inventive principles of this patent disclosure may also be combined in a single assembly. For example, the occupancy sensor and receiver, which would be wired on the line side, can be provided in a single assembly with a light fixture, power pack, junction box, etc.

### Data Logging

Some additional inventive principles of this patent disclosure relate to methods and apparatus for reporting and/or logging the operation of any of the occupancy sensors described above. For example, an occupancy sensor having the capability to control a load in response to an operating state of the occupancy sensor may be adapted to store a record of the times that it energized a load to replenish the energy storage device. Such a record may include information on the date, time, duration, etc., of any self-triggered events in which it energized the load, i.e., events that were not triggered by an occupancy determination. The stored record maybe retrieved for analysis, for example, through a wireless communication interface which may be the same as, or separate from the wireless interface used to control the load. Records can be kept by one or more additional receiver devices which can be plugged into the computer. A receiver device may be in the same room as the occupancy sensor to be monitored. The receiver may be connected to a computer or other data logging apparatus through any suitable type of connection such as USB, RS323, etc.

Alternatively, the occupancy sensor may be configured to send two different discernable types of signals to the receiver: one for a normal occupancy event, and another for a self-triggered event. The receiver may then store the record of self-triggered events. The record may be retrieved from the receiver through the wireless interface, or through any other suitable wired or wireless connection or data transfer mechanism such as a USB connection, Wi-Fi connection, Ethernet connection, removable memory card, etc.

As another alternative, the occupancy sensor may be configured to send two different discernable types of signals, each of which is received by a different apparatus. For example, normal occupancy events may be transmitted on a different frequency, or in a different format, encoding, etc., than self-triggered events. The receiver that controls the load may be configured to only respond to the normal occupancy events, while a separate receiver maybe used to route the self-triggered events to a computer or other data logging station. For example, in the embodiments of FIGS. 3, 4 and 7, a binding system maybe implemented so that the wall switch 56 only responds to wireless transmissions of normal occupancy events from the occupancy sensor, while computer 67 receives wireless transmissions of self-triggered events and logs the time, date, duration, etc., of the self-triggered events.

As a further elaboration, a computer or other data processing device may be configured as a gateway to handle self-triggered events from the occupancy sensor. In such an embodiment, normal occupancy events may be transmitted on a different frequency, or in a different format, encoding, etc., than self-triggered events. The receiver that controls the load is configured to only respond to the normal occupancy events, while the computer or other data processing device recognizes the self-triggered events and responds accordingly. For example, the computer may be configured to turn the load on for a specific period of time adequate to replenish the energy storage device in the occupancy sensor, then log the event for future evaluation.

The inventive principles of this patent disclosure have been described above with reference to some specific example embodiments, but these embodiments can be modified in arrangement and detail without departing from the inventive concepts. Such changes and modifications are considered to fall within the scope of the following claims.

1. A method comprising:
storing energy at an occupancy sensor;
operating the occupancy sensor for a substantial length of time using the stored energy;
controlling a load in response to the occupancy sensor; and
selectively transferring energy from the load to the occupancy sensor in response to an operating condition of the occupancy sensor.

2. The method of claim 1 wherein the operating condition comprises the amount of energy stored at the occupancy sensor such that energy is transferred from the load to the occupancy sensor when the amount of energy stored at the occupancy sensor is close to a level that is insufficient to operate the occupancy sensor.

3. (canceled)

4. The method of claim 2 where the occupancy sensor causes energy to be transferred from the load to the occupancy sensor by energizing the load.

5. (canceled)

6. (cancelled)

7. The method of claim 4 where energy is transferred from the load to the occupancy sensor through low-voltage wiring.

8. The method of claim 4 where the occupancy sensor energizes the load by simulating an occupancy event.

9. (canceled)

10. (canceled)

11. (cancelled)

12. (canceled)

13. The method of claim 1 wherein the occupancy sensor stores energy by harvesting energy from its environment.

14. The method of claim 1 wherein the operating condition comprises a level of power consumption of the occupancy sensor.

15. The method of claim 14 where:
the occupancy sensor has a first level of power consumption and a second level of power consumption that is greater than the first level of power consumption; and
energy is transferred from the load to the occupancy sensor when the occupancy sensor operates at the second level of power consumption.

16. The method of claim 15 wherein the occupancy sensor causes energy to be transferred from the load to the occupancy sensor by energizing the load.

17. The method of claim 16 where:
the occupancy sensor operates at the first level of power consumption while using a first sensing technology; and
the occupancy sensor operates at the second level of power consumption while using a second sensing technology.

18. The method of claim 17 where:
the first sensing technology comprises a passive sensing technology; and
the second sensing technology comprises an active sensing technology.

19. The method of claim 18 where:
the passive sensing technology comprises infrared sensing technology; and
the active sensing technology comprises ultrasonic sensing technology.

20. (canceled)

21. The method of claim 16 where:
the occupancy sensor is arranged to monitor a space and control a load associated with the monitored space;
the occupancy sensor operates at the first level of power consumption while a monitored space is unoccupied; and
the occupancy sensor operates at the second level of power consumption while the monitored space is occupied.

22. The method of claim 21 where:
the occupancy sensor uses passive infrared sensing technology while the monitored space is unoccupied; and
the occupancy sensor uses ultrasonic sensing technology while the monitored space is occupied.

23. (canceled)

24. (cancelled)

25. (canceled)

26. (cancelled)

27. The method of claim 14 where the occupancy sensor uses an energy conversion technology to store energy harvested from its environment.

28. The method of claim 27 where the energy conversion technology provides enough power to operate the occupancy sensor for a substantial length of time at the first level of power consumption.

29. An occupancy sensor comprising:
a sensing circuit to detect an occupant;
a control circuit to control a load in response to the sensing circuit;
a power source; and
an energy storage device to store energy from the power source and power the sensing circuit and the control circuit for a substantial length of time;
where the control circuit may control the load in response to an operating condition of the occupancy sensor.

30. The occupancy sensor of claim 29 wherein the operating condition comprises the amount of energy stored in the energy storage device.

31. The occupancy sensor of claim 30 wherein the control circuit is adapted to transmit a control signal to energize the load when the amount of energy stored in the energy storage device approaches a minimum operating level.

32. The occupancy sensor of claim 31 wherein the power source comprises an energy converter to harvest energy transmitted from the load.

33. The occupancy sensor of claim 31 where the power source comprises one or more terminals to connect the occupancy sensor to the load through a wired connection.

34. The occupancy sensor of claim 29 where the occupancy sensor uses a wireless technology to control the load.

35. The occupancy sensor of claim 29 where the operating condition comprises the level of power consumption of the occupancy sensor.

36. The occupancy sensor of claim 35 where:
the sensing circuit is a first sensing circuit having a first level of power consumption; and
the occupancy sensor further comprises a second sensing circuit having a second level of power consumption that is greater than the first level of power consumption.

37. The occupancy sensor of claim 36 where the control circuit is adapted to enable the second sensing circuit when power is available from the power source.

38. The occupancy sensor of claim 37 where:
the power source is a first power source arranged to receive energy from the load through a wired connection; and
the occupancy sensor further comprises a second power source including an energy converter to harvest energy from an environment in which the occupancy sensor is installed.

39. The occupancy sensor of claim 38 where:
the first sensor circuit uses power from the energy storage device and/or the second power supply when the load is de-energized;
the second sensor circuit is disabled when the load is de-energized; and
the second sensor circuit is enabled when the load is energized.

40. The occupancy sensor of claim 39 where:
the first sensor circuit uses passive infrared sensing technology; and
the second sensor circuit uses one of ultrasonic or audio sensing technology.

41. (canceled)

42. (canceled)

43. A system comprising:
an occupancy sensor configured to monitor a space and transmit a wireless control signal in response to detecting an occupant in the space;
a load associated with the space; and
a wireless receiver configured to control the load in response to the wireless control signal;
where the occupancy sensor includes:
an energy storage device to provide power to the occupancy sensor when the load is not energized; and
a power source configured receive energy from the load when the load is energized; and
where the occupancy sensor is adapted to energize the load when the amount of energy stored in the energy storage device reaches a predetermined threshold.

44. The system of claim 44 where the power source comprises a wired connection to the load.

45. The system of claim 44 where the power source comprises an energy converter to harvest energy from the load.

46. (canceled)

47. A system comprising:
an occupancy sensor configured to monitor a space and transmit a wireless control signal in response to detecting an occupant in the space;
a load associated with the space; and
a wireless receiver configured to control the load in response to the wireless control signal;
where the occupancy sensor includes:
a first sensing circuit for detecting the occupant in the space;
a second sensing circuit for detecting the occupant in the space;
an energy storage device to provide power to the occupancy sensor when the load is not energized; and
a connection to receive energy from the load when the load is energized; and
where the second sensing circuit is substantially disabled when the load is not energized.

48. The system of claim 47 where the occupancy sensor further comprises an energy converter to harvest energy from an environment of the occupancy sensor.

49. The system of claim 48 where:
the first sensing circuit comprises a passive infrared sensing circuit; and
the second sensing circuit comprises one or more from the group consisting of an ultrasonic or an audio sensing circuit.

50. (cancelled)

51. The system of claim 47 where the connection to the load comprises a wired connection.

52. An occupancy sensor comprising:
a first sensing circuit for detecting an occupant's presence in a space;
a second sensing circuit for detecting an occupant's presence in the space;
a control circuit to control a load in response to the first and second sensing circuits;
an energy storage device to provide power to the occupancy sensor when the load is not energized; and
an input to receive energy from the load when the load is energized;
where the second sensing circuit is substantially disabled when the load is not energized.

53. The occupancy sensor of claim 52 where the occupancy sensor controls the load via wireless communication.

54. The occupancy sensor of claim 52 where the input is adapted for a wired connection to the load.

55. The occupancy sensor of claim 52 where the second sensing circuit consumes substantially more power than the first sensing circuit.

56. (canceled)

57. (cancelled)

58. (canceled)

59. (cancelled)

60. (canceled)
